(19) United States
(12) Patent Application Publication
(10) Pub. No.: US 2017/0309366 A1
(43) Pub. Date: Oct. 26, 2017

(54) Electrical Device Comprising a Cross-linked Layer

(71) Applicant: NEXANS, PARIS (FR)

(72) Inventors: Jean-Francois LARCHE, FLEURIEU-SUR-SAONE (FR); Anthony COMBESSIS, Marseille (FR); Laurent KEROMNES, Chaponost (FR)

(21) Appl. No.: 15/514,087

(22) PCT Filed: Sep. 21, 2015
(86) PCT No.: PCT/FR2015/052519

§ 371 Date: Mar. 24, 2017

(30) Foreign Application Priority Data
Sep. 26, 2014 (FR) 14 59121

(51) Int. Cl. H01B 3/44; C08K 5/549; C08K 5/14

(52) U.S. Cl. CPC H01B 3/441; C08K 5/14; C08K 5/549

(57) ABSTRACT

The present invention relates to an electrical device (1, 20, 30) comprising a cross-linked layer (3, 4, 5) obtained on the basis of a cross-linkable polymer composition comprising a polymer material and particles with polyhedric structure, characterized in that the particles have a melting point of at most 200° C.

The present invention relates to an electrical device of the electric cable or electric cable accessory type, comprising at least one crosslinked layer.

It typically but not exclusively applies to the fields of low-voltage (in particular of less than 6 kV), medium-voltage (in particular from 6 to 45-60 kV) or high-voltage (in particular greater than 60 kV, and which can range up to 800 kV) power cables, whether they are direct current or alternating current.

Power cables typically comprise a central electrical conductor and at least one electrically insulating layer crosslinked by techniques well known to a person skilled in the art, in particular by the peroxide route.

The peroxide route is tending to be increasingly avoided with respect to the decomposition products of peroxide, which exhibit disadvantages during the manufacture of the cable, indeed even once the cable is in the operational configuration. This is because, during the crosslinking, the peroxides decompose and form crosslinking by-products, such as, in particular, methane, acetophenone, cumyl alcohol, acetone, tert-butanol, α-methylstyrene and/or water. The formation of water from cumyl alcohol is relatively slow and can occur after several months, indeed even a few years, once the cable is in the operational configuration. The risk of breakdown of the crosslinked layers is thus significantly increased. In addition, if the methane formed during the crosslinking stage is not discharged from the crosslinked layers, risks related to the explosiveness of methane and its ability to ignite cannot be ignored. This gas can also cause damage once the cable is put into service. Even if solutions exist for limiting the presence of methane within the cable, such as, for example, heat treating the cable in order to accelerate the diffusion of methane outside the cable, they become lengthy and expensive when the thickness of the crosslinked layers is high.

However, there still exists a high demand to provide novel crosslinked compositions for an electrical device, exhibiting optimized electrical and mechanical properties and also optimized processing, in particular for applications in the field of electric cables and electric cable accessories.

The aim of the present invention is to overcome the disadvantages of the techniques of the prior art by providing an electrical device comprising a crosslinked layer, the manufacture of which is more environmentally friendly and significantly limits the presence of crosslinking byproducts, such as, for example, methane and/or water, while guaranteeing good electrical and mechanical properties.

A subject matter of the present invention is an electrical device comprising a crosslinked layer obtained from a crosslinkable polymer composition comprising a polymer material and particles having a polyhedral structure, characterized in that the particles have a melting point of at most 200° C.

By virtue of the invention, the crosslinked layer of the electrical device exhibits optimum electrical properties, while guaranteeing a good level of crosslinking.

In addition, the crosslinked layer of the invention can advantageously make it possible to significantly limit the presence of crosslinking byproducts, while guaranteeing good mechanical properties during the life of the cable. More particularly, the invention makes it possible to significantly limit the use of organic peroxide for crosslinking the polymer materials, in particular olefin polymers.

Particles Having a Polyhedral Structure

In the present invention, the melting point of the particles having a polyhedral structure is conventionally measured at the melting peak by differential scanning calorimetry (DSC) with a temperature gradient of 10° C./min under a nitrogen atmosphere.

The melting point of the particles having a polyhedral structure can be at most 180° C., preferably at most 100° C., preferably at most 50° C., and preferably at most 30° C.

The particles having a polyhedral structure according to the invention are particles having a three-dimensional geometric shape, more particularly known as “cage” structure, having in particular flat polygonal faces which meet along straight-line segments or edges.

More particularly, the particles of the invention comprise Si—O groups or in other words groups comprising silicon and oxygen atoms, the silicon atom being covalently bonded to the oxygen atom.

In a preferred embodiment, the particles of the invention can be POSSs (polyhedral oligomeric silsesquioxanes).

POSSs are conventionally inorganic silicon-oxygen cages with structures of the SiO_{3/2} type and organic substituents R covalently bonded to the silicon atoms of the cage.

The general formula of POSSs is of the RₙTₙ type, in which T=SiO_{3/2}, n being an integer. Preferably, n is an even integer which can be equal to 8, 6, 10, 12, 14 or 16.

The following structure illustrates the general formula of a POSS with n=8:

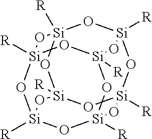

In the POSSs according to the invention, the R groups, which are identical or different, can be chosen from methyl, ethyl, propyl, butyl, isooctyl, phenyl, cyclopentyl, cyclohexyl and cycloheptyl groups.

One or more R groups can also be substituted with a reactive functional group chosen, for example, from a vinyl (CH═CH₂), epoxy (—CH₂—O—CH₂— cyclicether), carboxylic acid, silane, acrylate, methacrylate, alcohol, amine and imide functional group. When the POSS particle comprises at least one vinyl functional group, it is possible to refer to vinylated POSS.

By way of example, in the context of the invention, mention may be made of the following POSSs:
octavinyl POSS, sold by Hybrid Plastics under the reference OL1170, having a melting point of 177° C.:

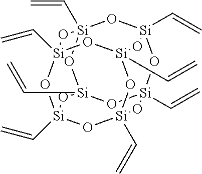

N-phenylaminopropyl POSS, sold by Hybrid Plastics under the reference AM0281, this POSS being liquid at 25° C. (i.e., melting point of less than 25° C.)

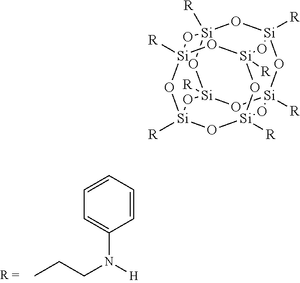

methacryl POSS, sold by Hybrid Plastics under the reference MA0735, this POSS being liquid at 25° C. (i.e., melting point of less than 25° C.)

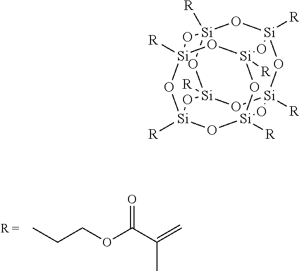

epoxycyclohexyl POSS, sold by Hybrid Plastics under the reference EP0408, this POSS being liquid at 25° C. (i.e., melting point of less than 25° C.)

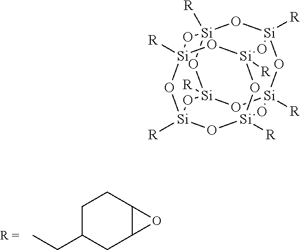

glycidyl POSS, sold by Hybrid Plastics under the reference EP0409, this POSS being liquid at 25° C. (i.e., melting point of less than 25° C.)

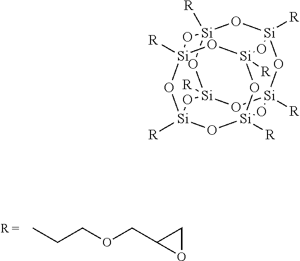

The particles of the invention are preferably nanoparticles.

Inorganic nanoparticles typically have at least one their dimensions of nanometric size (10⁻⁹ meter).

The term “dimension” is understood to mean the number-average dimension of all of the nanoparticles of a given population, this dimension being conventionally determined by methods well known to a person skilled in the art.

The dimension of the nanoparticles according to the invention can, for example, be determined by electron microscopy, in particular by scanning electron microscopy (SEM) or transmission electron microscopy (TEM).

The number-average dimension of the nanoparticles can in particular be at most 400 nm, preferably at most 300 nm, and more preferably at most 100 nm.

Particularly preferably, the number-average dimensioning of the nanoparticles is at least 1 nm and at most 100 nm, preferably at least 1 nm and at most 50 nm, and particularly preferably at least 1 and at most 3 nm.

In a specific embodiment, the crosslinkable composition can comprise a sufficient amount of particles having a polyhedral structure to be able to obtain the desired properties.

By way of example, the crosslinkable polymer composition can comprise at most 20.0% by weight of particles having a polyhedral structure and preferably at most 10.0% by weight of particles having a polyhedral structure, with respect to the total weight of the crosslinkable composition. In addition, the crosslinkable composition can comprise at least 0.1% by weight of particles having a polyhedral structure, with respect to the total weight of the crosslinkable polymer composition.

The Polymer Material

The polymer material of the invention can comprise one or more polymer(s), it being possible for the term “polymer” to be understood by any type of polymer well known to a person skilled in the art, such as homopolymer or copolymer (e.g., block copolymer, random copolymer, terpolymer, and the like).

The polymer can be of the thermoplastic or elastomer type and can be crosslinked by techniques which are well known to a person skilled in the art.

In a specific embodiment, the polymer material, or in other words the polymer matrix of the crosslinkable composition, can comprise one or more olefin polymers and preferably one or more ethylene polymers and/or one or more propylene polymers. An olefin polymer is conventionally a polymer obtained from at least one olefin monomer.

More particularly, the polymer material comprises more than 50% by weight of olefin polymer(s), preferably more than 70% by weight of olefin polymer(s) and particularly preferably more than 90% by weight of olefin polymer(s), with respect to the total weight of polymer material. Preferably, the polymer material is composed solely of one or more olefin polymer(s).

By way of example, the polymer material of the invention can comprise one or more olefin polymers chosen from a linear low density polyethylene (LLDPE); a very low density polyethylene (VLDPE); a low density polyethylene (LDPE); a medium density polyethylene (MDPE); a high density polyethylene (HDPE); an ethylene/propylene elastomer copolymer (EPR); an ethylene/propylene/diene monomer terpolymer (EPDM); a copolymer of ethylene and of vinyl ester, such as a copolymer of ethylene and of vinyl acetate (EVA); a copolymer of ethylene and of acrylate, such as a copolymer of ethylene and of butyl acrylate (EBA) or a copolymer of ethylene and of methyl acrylate (EMA); a copolymer of ethylene and of α-olefin, such as a copolymer of ethylene and of octene (PEO) or a copolymer of ethylene and of butene (PEB); a functionalized olefin polymer; polypropylene; a propylene copolymer; and one of their mixtures.

In a specific embodiment, the polymer material is a nonpolar material, or in other words the polymer material comprises more than 60% by weight of nonpolar polymer(s) and preferably more than 80% by weight of nonpolar polymer(s) and preferably 100% by weight of nonpolar polymer(s), with respect to the total weight of polymer material in the crosslinkable polymer composition. Mention may be made, as example of polar polymer, of polymers having acrylate, epoxide and/or vinyl functional groups. This specific embodiment may be preferred when the crosslinked layer of the invention is used as electrical insulating layer.

The crosslinkable polymer composition of the invention can comprise at least 30% by weight of polymer material, preferably at least 50% by weight of polymer material, preferably at least 80% by weight of polymer material and preferably at least 90% by weight of polymer material, with respect to the total weight of the crosslinkable polymer composition.

The Crosslinkable Polymer Composition

The polymer composition of the invention is a crosslinkable composition.

It can advantageously be devoid of halogenated compounds.

The crosslinkable polymer composition is crosslinked by crosslinking processes well known to a person skilled in the art, such as, for example, peroxide crosslinking, crosslinking by an electron beam, silane crosslinking, crosslinking by ultraviolet radiation, and the like.

The preferred process for crosslinking the polymer composition is peroxide crosslinking. On this account, the crosslinkable polymer composition can comprise a crosslinking agent of the organic peroxide type.

The polymer composition can comprise a sufficient amount of one or more crosslinking agents, in order to obtain said crosslinked layer.

By way of example, the crosslinkable polymer composition can comprise from 0.01 to 10.0% by weight of crosslinking agent, with respect to the total weight of the crosslinkable polymer composition.

Preferably, in particular during the use of a crosslinking agent of organic peroxide type, the crosslinkable polymer composition can advantageously comprise at most 5.0% by weight of crosslinking agent, preferably at most 2.0% by weight of crosslinking agent, preferably at most 1.0% by weight of crosslinking agent, and preferably at most 0.5% by weight of crosslinking agent, with respect to the total weight of the crosslinkable polymer composition.

In a specific embodiment, the crosslinkable polymer composition of the invention does not comprise a crosslinking agent of the organic peroxide type.

In another specific embodiment, the crosslinkable polymer composition does not comprise an amphiphilic dispersing agent. More particularly, the crosslinkable polymer composition may not comprise an amphiphilic dispersing agent chosen from an amphiphilic carboxylic acid, an amphiphilic amine, a vegetable oil having a triglyceridyl structure, an oil having an ester group and a mixture of these compounds.

The Fillers

The crosslinkable polymer composition of the invention can additionally comprise one or more fillers.

The filler of the invention can be an inorganic or organic filler. It can be chosen from a flame-retardant filler and an inert filler (or noncombustible filler).

By way of example, the flame-retardant filler can be a hydrated filler chosen in particular from metal hydroxides, such as, for example, magnesium dihydroxide (MDH) or aluminum trihydroxide (ATH). These flame-retardant fillers act mainly by the physical route by decomposing endothermically (e.g., release of water), which has the consequence of lowering the temperature of the crosslinked layer and of limiting the propagation of the flames along the electrical device. The term flame retardant properties is used in particular.

For its part, the inert filler can be chalk, talc, clay (e.g., kaolin), carbon black or carbon nanotubes.

The filler can also be an electrically conducting filler chosen in particular from carbon-based fillers. Mention may be made, by way of example, as electrically conducting filler, of fillers chosen from carbon blacks, graphenes, carbon nanotubes and one of their mixtures.

According to a first alternative form, the electrically conducting filler may be preferred in order to obtain a crosslinked “semiconducting” layer and may be introduced into the polymer composition in an amount sufficient to render the composition conducting by percolation, this amount varying in particular according to the type and the morphology of electrically conducting filler selected. By way of example, the appropriate amount of the electrically conducting filler can be between 8 and 40% by weight in the crosslinkable polymer composition for carbon black and can be from 0.1 to 5% by weight in the crosslinkable polymer composition for carbon nanotubes.

According to a second alternative form, the electrically conducting filler may be preferred in order to obtain a crosslinked “electrically insulating” layer and may be used in a small amount in order to improve the dielectric properties of an electrically insulating layer, without it becoming semiconducting.

The crosslinkable polymer composition can comprise at least 1% by weight of filler(s), preferably at least 10% by weight of filler(s), and preferably at most 50% by weight of filler(s), with respect to the total weight of the crosslinkable polymer composition.

According to another characteristic of the invention and in order to guarantee a “halogen-free” or more particularly “HFFR” (Halogen-Free Flame Retardant) electrical device, the electrical device, or in other words the components which make up said electrical device, preferably does/do not comprise halogenated compounds. These halogenated compounds can be of any nature, such as, for example, fluoropolymers or chloropolymers, such as polyvinyl chloride (PVC), halogenated plasticizers, halogenated inorganic fillers, and the like.

The Additives

In addition, the crosslinkable polymer composition of the invention can typically comprise additives in an amount of 0.01 to 20% by weight in the crosslinkable polymer composition.

The additives are well known to a person skilled in the art and can, for example, be chosen from:
protective agents, such as antioxidants, UV stabilizers, agents for combating copper or agents for combating water treeing,
processing aids, such as plasticizers, viscosity reducers or oils,
compatibilizing agents,
coupling agents,
scorch retardants,
pigments,
crosslinking catalysts,
and one of their mixtures.

More particularly, the antioxidants make it possible to protect the composition from the thermal stresses brought about during the stages of manufacture of the device or of operation of the device.

The antioxidants are preferably chosen from:
sterically hindered phenolic antioxidants, such as tetrakis[methylene(3,5-di(t-butyl)-4-hydroxyhydro-cinnamate)]methane, octadecyl 3-(3,5-di(t-butyl)-4-hy-droxyphenyl)propionate, 2,2′-thiodiethylenebis[3-(3,5-di(t-butyl)-4-hydroxyphenyl)propionate], 2,2′-thiobis(6-(t-butyl)-4-methylphenol), 2,2′-methylenebis(6-(t-butyl)-4-methylphenol), 1,2-bis(3,5-di(t-butyl)-4-hydroxyhydro-cinnamoyl)hydrazine and 2,2′-oxamidodiethyl bis[3-(3,5-di(t-butyl)-4-hydroxyphenyl)propionate];
thioethers, such as 4,6-bis(octylthiomethyl)-o-cresol, bis[2-methyl-4-{3-(n-(C₁₂ or C₁₄)alkylthio)-propionyloxy}-5-(t-butyl)phenyl] sulfide and thiobis[2-(t-butyl)-5-methyl-4,1-phenylene]bis[3-(dodecylthio)pro-pionate];
sulfur-based antioxidants, such as dioctadecyl 3,3′-thiodipropionate or didodecyl 3,3′-thiodipropionate;
phosphorus-based antioxidants, such as phosphites or phosphonates, such as, for example, tris[2,4-di(t-butyl)phenyl] phosphite or bis[2,4-di(t-butyl)phenyl] pentaerythritol diphosphite; and
amine-type antioxidants, such as phenylenediamines (IPPD, 6PPD, and the like), diphenylamine styrenes, diphenylamines, mercapto-benzimidazoles and polymerized 2,2,4-trimethyl-1,2-dihydroquinoline (TMQ), the latter type of antioxidant being particularly preferred in the composition of the invention.

The TMQs can have different grades, namely:
a “standard” grade with a low degree of polymerization, that is to say with a residual monomer content of greater than 1% by weight and having a residual NaCl content which can range from 100 ppm to more than 800 ppm (parts per million by weight);
a “high degree of polymerization” grade with a high degree of polymerization, that is to say with a residual monomer content of less than 1% by weight and having a residual NaCl content which can range from 100 ppm to more than 800 ppm;
a “low content of residual salt” grade with a residual NaCl content of less than 100 ppm.

TMQ-type antioxidants are preferably used when the polymer composition comprises electrically conducting fillers.

The type of stabilizing agent and its content in the composition of the invention are conventionally chosen according to the maximum temperature to which the polymers are subjected during the production of the mixture and during their processing, in particular by extrusion, and also according to the maximum duration of exposure to this temperature.

The purpose of the crosslinking catalysts is to help in the crosslinking. The crosslinking catalyst can be chosen from Lewis acids, Brönsted acids and tin-based catalysts, such as, for example, dibutyltin dilaurate (DBTL).

The Crosslinked Layer and the Electrical Device

In the present invention, the crosslinked layer can be easily characterized by the determination of its gel content according to the standard ASTM D2765-01.

More particularly, said crosslinked layer can advantageously have a gel content, according to the standard ASTM D2765-01 (extraction with xylene), of at least 50%, preferably of at least 70%, preferably of at least 80% and particularly preferably of at least 90%.

The crosslinked layer of the invention can be chosen from an electrically insulating layer, a semiconducting layer, a stuffing component and a protective sheath. The device of the invention can, of course, comprise combinations of at least two of these four types of crosslinked layer. The crosslinked layer of the invention can be the outermost layer of the electrical device.

In the present invention, “electrically insulating layer” is understood to mean a layer, the electrical conductivity of which can be at most 1·10⁻⁹ S/m and preferably at most 1·10⁻¹⁰ S/m (siemens per meter) (at 25° C.)

When the crosslinked layer of the invention is an electrically insulating layer, the polymer composition of the invention can comprise at least 70% by weight of polymer material, thus forming the polymer matrix of the invention.

In the present invention, “semiconducting layer” is understood to mean a layer, the electrical conductivity of which can be at least 1·10⁻⁹ S/m (siemens per meter), preferably at least 1·10⁻³ S/m, and preferably can be less than 1·10³ S/m (at 25° C.)

When the crosslinked layer of the invention is a semiconducting layer, the polymer composition of the invention can comprise an electrically conducting filler in an amount sufficient to render the crosslinked layer of the invention semiconducting.

The crosslinked layer of the invention can be a layer extruded or a layer molded by processes well known to a person skilled in the art.

The electrical device of the invention relates more particularly to the field of electric cables and electric cable accessories, functioning under direct current (DC) or under alternating current (AC).

The electrical device of the invention can be an electric cable or an electric cable accessory.

According to a first embodiment, the device according to the invention is an electric cable comprising an elongated electrically conducting component surrounded by said crosslinked layer.

In this embodiment, the crosslinked layer is preferably a layer extruded by techniques well known to a person skilled in the art.

The crosslinked layer of the invention can surround the elongated electrically conducting component according to several alternative forms.

According to a first alternative form, the crosslinked layer can be directly in physical contact with the elongated electrically conducting component.

Reference is made, in this first alternative form, to low-voltage cable.

According to a second alternative form, the crosslinked layer can be at least one of the layers of an insulating system comprising:
a first semiconducting layer surrounding the electrically conducting component,
an electrically insulating layer surrounding the first semiconducting layer, and
a second semiconducting layer surrounding the electrically insulating layer.

More particularly, the elongated electrically conducting component can be surrounded by a first semiconducting layer, an electrically insulating layer surrounding the first semiconductor layer, and a second semiconducting layer surrounding the electrically insulating layer, the crosslinked layer being at least one of these three layers, and the crosslinked layer preferably being the electrically insulating layer.

Reference is made, in this second alternative form, to medium- or high-voltage cable.

According to a second embodiment, the device according to the invention is an electric cable accessory, said accessory comprising said crosslinked layer.

Said accessory is intended to surround, or surrounds when it is positioned around the cable, the elongated electrically conducting component of an electric cable. More particularly, said accessory is intended to surround or surrounds an electric cable and it is preferably intended to surround or surrounds at least a portion or end of an electric cable. The accessory can in particular be an electric cable joint or termination.

The accessory can typically be a hollow longitudinal body, such as, for example, an electric cable joint or termination, in which at least a portion of an electric cable is intended to be positioned. The accessory comprises at least one semiconducting component and at least one electrically insulating component, these components being intended to surround at least a portion or end of an electric cable. The semiconducting component is well known for controlling the geometry of the electric field, when the electric cable, in combination with said accessory, is under voltage.

The crosslinked layer of the invention can be said semiconducting component and/or said electrically insulating component of the accessory.

When the accessory is a joint, the latter makes it possible to connect together two electric cables, the joint being intended to surround or surrounding, at least in part, these two electric cables. More particularly, the end of each electric cable intended to be connected is positioned inside said joint.

When the device of the invention is an electric cable termination, the termination is intended to surround or surrounds, at least in part, an electric cable. More particularly, the end of the electric cable intended to be connected is positioned inside said termination.

When the electric device is an electric cable accessory, the crosslinked layer is preferably a layer molded by techniques well known to a person skilled in the art.

In the present invention, the elongated electrically conducting component of the electric cable can be a metal wire or a plurality of metal wires, which is/are or is/are not twisted, in particular made of copper and/or of aluminum, or one of their alloys.

Another subject matter of the invention is a process for the manufacture of an electric cable according to the invention, characterized in that it comprises the following stages:
i. extruding the crosslinkable polymer composition around an elongated electrically conducting component, in order to obtain an extruded layer, and
ii. crosslinking the extruded layer of stage i.

Stage i can be carried out by techniques well known to a person skilled in the art, using an extruder.

During stage i, the composition at the extruder outlet is “noncrosslinked”, the temperature and also the time of processing within the extruder being consequently optimized.

“Noncrosslinked” is understood to mean a layer, the gel content of which according to the standard ASTM D2765-01 (extraction with xylene) is at most 20%, preferably at most 10%, preferably at most 5% and particularly preferably 0%,

There is thus obtained, at the extruder outlet, a layer extruded around said electrically conducting component which may or may not be directly in physical contact with said electrically conducting component.

Prior to stage i, the constituent components of the polymer composition of the invention can be mixed, in particular with the polymer material in the molten state, in order to obtain a homogeneous mixture. The temperature within the mixer can be sufficient to obtain a polymer material in the molten state but is limited in order to prevent the decomposition of the crosslinking agent, when it exists, and thus the crosslinking of the polymer material. The homogeneous mixture can then be granulated by techniques well known to a person skilled in the art. These granules can subsequently feed an extruder in order to carry out stage i.

Stage ii can be carried out by the thermal route, for example using a continuous vulcanization line (CV line), a steam tube, a bath of molten salt, an oven or a thermal chamber, these techniques being well known to a person skilled in the art.

Stage ii thus makes it possible to obtain a crosslinked layer having in particular a gel content, according to the standard ASTM D2765-01, of at least 40%, preferably of at least 50%, preferably of at least 60% and particularly preferably of at least 70%.

Another subject matter of the invention is a process for the manufacture of an electric cable accessory, characterized in that it comprises the following stages:

i. molding the crosslinkable polymer composition, in order to obtain a molded layer, and

ii. crosslinking the molded layer of stage i.

Stage i can be carried out by techniques well known to a person skilled in the art, in particular by molding or extrusion-molding.

The constituent compounds of the polymer composition of the invention can be mixed prior to stage i, as described above for the manufacture of a cable.

Stage ii can be carried out by the thermal route, for example using a heating mold, which can be the mold used in stage i. In the mold, the composition of stage i can subsequently be subjected to a sufficient temperature and for a sufficient time to be able to obtain the desired crosslinking. A molded and crosslinked layer is then obtained.

Stage ii thus makes it possible to obtain a crosslinked layer having in particular a gel content, according to the standard ASTM D2765-01, of at least 40%, preferably of at least 50%, preferably of at least 60% and particularly preferably of at least 70%.

In the present invention, the crosslinking temperature and the crosslinking time of the extruded and/or molded layer employed are in particular functions of the thickness of the layer, of the number of layers, of the presence or not of a crosslinking catalyst, of the type of crosslinking, and the like.

A person skilled in the art may easily determine these parameters by monitoring the change in the crosslinking by virtue of the determination of the gel content according to the standard ASTM D2765-01 in order to obtain a crosslinked layer.

When an extruder is used, the temperature profile of the extruder and the extrusion rate are parameters which a person skilled in the art may also vary in order to guarantee that the desired properties are obtained.

Other characteristics and advantages of the present invention will become apparent in the light of the description of nonlimiting examples of an electric cable according to the invention and electric cable accessory according to the invention, made with reference to the figures.

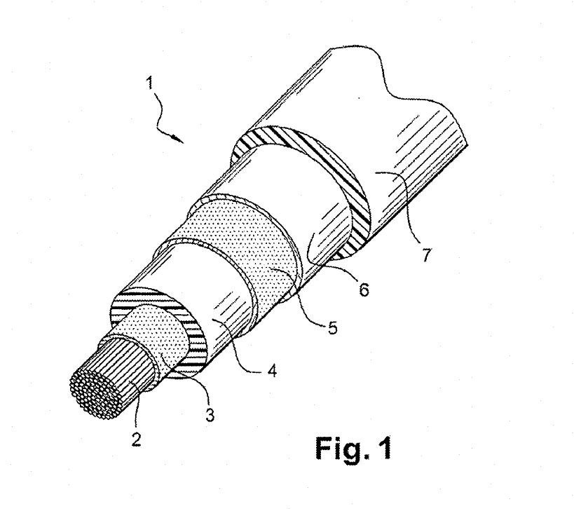

FIG. 1 represents a diagrammatic view of an electric cable according to a preferred embodiment in accordance with the invention.

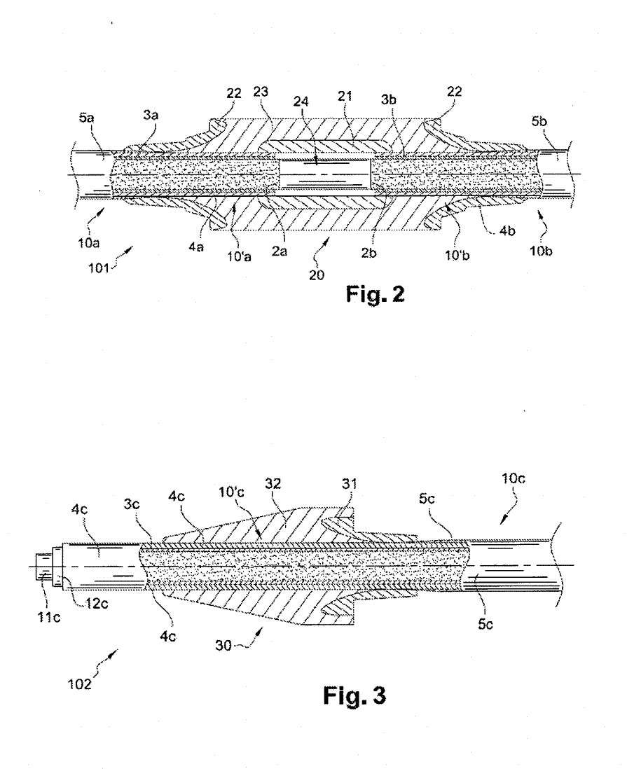

FIG. 2 represents a diagrammatic view of an electrical device according to the invention comprising a joint in longitudinal section, this joint surrounding the ends of two electric cables.

FIG. 3 represents a diagrammatic view of an electrical device according to a first alternative form of the invention comprising a termination in longitudinal section, this termination surrounding the end of a single electric cable.

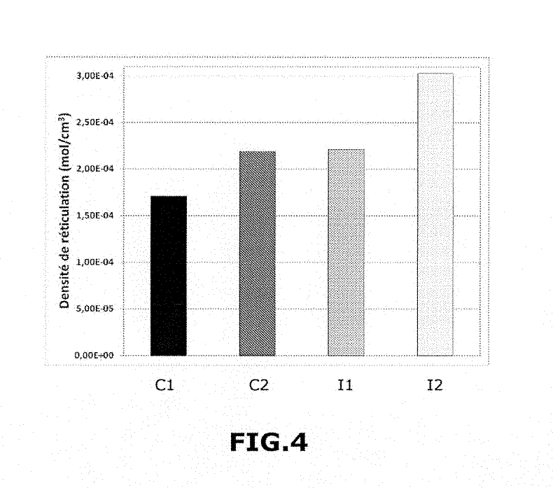

FIG. 4 represents histograms relating to the crosslinking density for crosslinked layers according to the invention and according to comparative compositions.

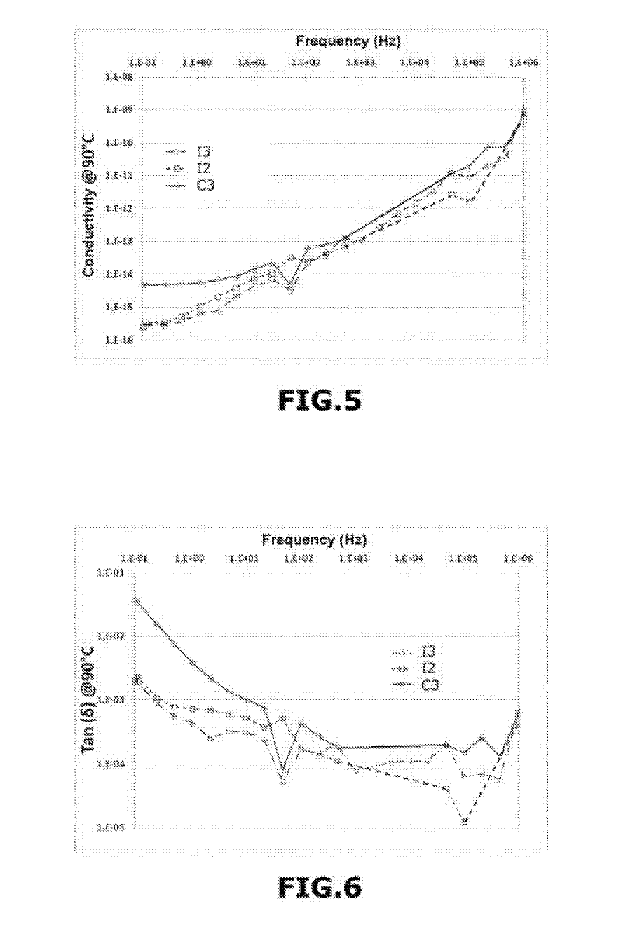

FIG. 5 represents the conductivity at 90° C. as a function of the frequency (Hz) for crosslinked layers according to the invention and according to comparative compositions.

FIG. 6 represents the tangent delta (tan(δ)) at 90° C. as a function of the frequency (Hz) for crosslinked layers according to the invention and according to comparative compositions.

For reasons of clarity, only the components essential for the understanding of the invention have been represented diagrammatically, this being done without observing a scale.

The medium- or high-voltage power cable 1, illustrated in FIG. 1, comprises an elongated central conducting component 2, in particular made of copper or of aluminum. The power cable 1 additionally comprises several layers positioned successively and coaxially around this conducting component 2, namely: a first semiconducting layer 3 referred to as “inner semiconducting layer”, an electrically insulating layer 4, a second semiconducting layer 5 referred to as “outer semiconducting layer”, an earthing and/or protective metal shield 6 and an external protective sheath 7.

The electrically insulating layer 4 is an extruded and crosslinked layer obtained from the crosslinkable polymer composition according to the invention.

The semiconducting layers are also extruded and crosslinked layers which can be obtained from the crosslinkable polymer composition according to the invention.

The presence of the metal shield 6 and of the external protective sheath 7 is preferential but not essential, this cable structure being as such well known to a person skilled in the art.

FIG. 2 represents a device 101 comprising a joint 20 surrounding, in part, two electric cables 10a and 10b.

More particularly, the electric cables 10a and 10b respectively comprise an end 10′a and 10′b which are intended to be surrounded by the joint 20.

The body of the joint 20 comprises a first semiconducting component 21 and a second semiconducting component 22 separated by an electrically insulating component 23, said semiconducting components 21, 22 and said electrically insulating component 23 surrounding the ends 10′a and 10′b respectively of the electric cables 10a and 10b.

This joint 20 makes it possible to electrically connect the first cable 10a to the second cable 10b, in particular by virtue of an electrical connector 24 positioned at the center of the joint 20.

At least one of the components chosen from the first semiconducting component 21, the second semiconducting component 22 and said electrically insulating component 23 can be a crosslinked layer as described in the invention.

The first electric cable 10a comprises an electrical conductor 2a surrounded by a first semiconducting layer 3a, an electrically insulating layer 4a surrounding the first semiconducting layer 3a, and a second semiconducting layer 5a surrounding the electrically insulating layer 4a.

The second electric cable 10b comprises an electrical conductor 2b surrounded by at least one first semiconducting layer 3b, an electrically insulating layer 4b surrounding the first semiconducting layer 3b, and a second semiconducting layer 5b surrounding the electrically insulating layer 4b.

These electric cables 10a and 10b can be those described in the present invention.

At said end 10′a, 10′b of each electric cable 10a, 10b, the second semiconducting layer 5a, 5b is at least partially denuded in order for the electrically insulating layer 4a, 4b to be at least partially positioned inside the joint 20, without being covered with the second semiconducting layer 5a, 5b of the cable.

Inside the joint 20, the electrically insulating layers 4a, 4b are directly in physical contact with the electrically insulating component 23 and the first semiconducting component 21 of the joint 20. The second semiconducting layers 5a, 5b are directly in physical contact with the second semiconducting component 22 of the joint 20.

FIG. 3 represents a device 102 comprising a termination 30 surrounding a single electric cable 10c.

More particularly, the electric cable 10c comprises an end 10′c intended to be surrounded by the termination 30.

The body of the termination 30 comprises a semiconducting component 31 and an electrically insulating component 32, said semiconducting component 31 and said electrically insulating component 32 surrounding the end 10′c of the electric cable 10c.

At least one of the components chosen from the semiconducting component 31 and the electrically insulating component 32 can be a crosslinked layer as described in the invention.

The electric cable 10c comprises an electrical conductor 2c surrounded by a first semiconducting layer 3c, an electrically insulating layer 4c surrounding the first semiconducting layer 3c, and a second semiconducting layer 5c surrounding the electrically insulating layer 4c.

This electric cable 10c can be that described in the present invention.

At said end 10′c of the electric cable 10c, the second semiconducting layer 5c is at least partially denuded in order for the electrically insulating layer 4c to be at least partially positioned inside the termination 30, without being covered with the second semiconducting layer 5c of the cable.

Inside the termination 30, the electrically insulating layer 4c is directly in physical contact with the electrically insulating component 32 of the termination 30. The second semiconducting layer 5c is directly in physical contact with the semiconducting component 31 of the joint 30.

### EXAMPLES

1. Electrically Insulating Crosslinkable Polymer Compositions

Crosslinkable polymer compositions, the amounts of the compounds of which are expressed as percentages by weight with respect to the total weight of the polymer composition, are collated in table 1 below.

The polymer material in table 1 is composed solely of EPDM.

The compositions C1 to C3 are comparative tests and the compositions I1 to I3 are in accordance with the invention.

TABLE 1

| | Crosslinkable polymer compositions | | | | | |
|---|---|---|---|---|---|---|
| | C1 | C2 | C3 | I1 | I2 | I3 |
| Polymer | 99.5 | 99.0 | 88.0 | 99.0 | 98.5 | 88.0 |
| material | | | | | | |
| Particles I | 0 | 0 | 0 | 0.5 | 0.5 | 10.0 |
| Particles C | 0 | 0 | 10.0 | 0 | 0 | 0 |
| Crosslinking | 0.5 | 1.0 | 2.0 | 0.5 | 1.0 | 2.0 |
| agent | | | | | | |

The origins of the compounds of table 1 are as follows:
Polymer material is EPDM sold by ExxonMobil under the reference Vistalon 1703P;
Particles I are particles of the POSS type, sold by Hybrid Plastics under the reference OL1170 (Octavinyl POSS), the melting point of which is 177° C.;
Particles C are particles of the POSS type, sold by Hybrid Plastics under the reference OL1118 (allylisobutyl POSS), the melting point of which is 246° C.;
Crosslinking agent is an organic peroxide of the dicumyl peroxide (DCP) type, sold by Arkema under the reference Luperox DCP, the half-life of which is 1 minute at 175° C.

2. Preparation of the Crosslinking Layers

The combinations calculated in table 1 are processed as follows.

The polymer is introduced onto an open mill at a temperature of 120° C. The particles and also the crosslinking agent are added on a roller at the same temperature, the mixing conditions (temperature and duration) being such that the crosslinking agent does not decompose during this mixing stage. Preforms are thus obtained.

The peroxide crosslinking is subsequently carried out during the manufacture of the molded plaques from these preforms. For this, the preforms are molded under a pressure of 200 bar at 180° C. for approximately 8 minutes, the molding temperature then making it possible for the crosslinking agent to decompose. The plaques obtained are thus crosslinked and have a thickness of approximately 1 mm.

3. Characterization of the Crosslinked Layers

The crosslinking density (v), the conductivity at 90° C. and the tangent delta (tan δ) at 90° C. were measured starting from the plaques formed above, according to the following methods.

3.1. The Crosslinking Density (v)

The crosslinking density was measured by DMA (Dynamic Mechanical Analysis) using test specimens with a thickness of approximately 1 mm stressed under tension from 30 to 150° C. with a temperature rise gradient of 3° C. min⁻¹.

The stressing frequency was set at 1 Hz and the strain at 0.1%.

The crosslinking density is obtained via the measurement of the storage modulus at 120° C. according to the well-established formula of rubber elasticity:

$$v = \frac{ρ}{Mc} and Mc \frac{3 ρ RT}{{E}_{r}^{′}}$$

with R being the ideal gas constant, T the temperature at which the modulus E′ is taken, E′ the value of the rubber modulus (in this instance at 120° C.) and p the density of the polymer at this temperature.

3.2. The Conductivity and the Tangent Delta (Tan δ), at 90° C.

The conductivity and the tangent delta (or loss factor) were measured by dielectric spectroscopy.

The tests were carried out on samples with a thickness of approximately 1 mm, over a range of frequencies at 10⁻¹ to 10⁶ Hz, with a voltage of 1 V. The temperature at 90° C. was applied during the test.

4. Results

The results obtained are calculated in FIGS. 4, 5 and 6.

FIG. 4 represents histograms related to the crosslinking density for crosslinked layers according to the invention and according to comparative compositions.

The composition I1 clearly shows a crosslinking density substantially identical to that of the composition C2, it being known that the composition I1, with particles according to the invention, comprises half as much organic peroxide as the composition C2.

In addition, it is also noticed that the composition I2 exhibits a markedly greater crosslinking density than that of the composition C2, it being known that the composition I2, with particles according to the invention, comprises an identical amount of organic peroxide to the composition C2.

Consequently, the crosslinkable polymer compositions according to the invention exhibit better levels of crosslinking and thus a better mechanical strength.

The crosslinkable polymer compositions according to the invention in addition make it possible to advantageously reduce the amounts of organic peroxide used for equivalent thermomechanical properties: risks of electrical breakdown due to the crosslinking byproducts (formed during the decomposition of these same peroxides) are de facto significantly limited, indeed even prevented.

FIGS. 5 and 6 respectively represent the conductivity at 90° C. as a function of the frequency (Hz) and the tangent delta (tan(δ)) (or tangent of the loss angle) at 90° C. as a function of the frequency (Hz), for crosslinked layers according to the invention and according to comparative compositions.

It is clearly noticed that the compositions I2 and I3 according to the invention exhibit a much lower loss at 0.1 Hz than the comparative composition C3.

Specifically, the results at 0.1 Hz are calculated in the following table 2:

TABLE 2

| Crosslinkable compositions | I2 | I3 | C3 |
|---|---|---|---|
| Conductivity at 90° C. | 2.51 × 10⁻¹⁶ | 2.70 × 10⁻¹⁶ | 4.77 × 10⁻¹⁵ |
| Tangent delta at 90° C. | 1.98 × 10⁻³ | 2.10 × 10⁻³ | 3.77 × 10⁻² |

Consequently, the crosslinkable polymer compositions according to the invention exhibit better dielectric properties (i.e., better electrical insulation).

1. An electrical device (1, 20, 30) comprising a crosslinked layer (3, 4, 5) obtained from a crosslinkable polymer composition comprising a polymer material and particles having a polyhedral structure, characterized in that the particles have a melting point of at most 200° C.

2. The device as claimed in claim 1, characterized in that the particles comprise Si—O groups.

3. The device as claimed in claim 1 or 2, characterized in that the particles are POSSs (polyhedric oligomeric silsesquioxanes).

4. The device as claimed in any one of the preceding claims, characterized in that the particles comprise at least one vinyl (CH═CH₂) functional group.

5. The device as claimed in any one of the preceding claims, characterized in that the particles are nanoparticles.

6. The device as claimed in any one of the preceding claims, characterized in that the crosslinkable polymer composition comprises at most 20.0% by weight of particles having a polyhedral structure and preferably at most 10.0% by weight of particles having a polyhedral structure, with respect to the total weight of the crosslinkable polymer composition.

7. The device as claimed in any one of the preceding claims, characterized in that the crosslinkable polymer composition comprises a crosslinking agent.

8. The device as claimed in claim 7, characterized in that the crosslinking agent is an organic peroxide.

9. The device as claimed in claim 8, characterized in that the crosslinkable polymer composition comprises less than 1.0% by weight of organic peroxide, with respect to the total weight of the crosslinkable polymer composition.

10. The device as claimed in any one of the preceding claims, characterized in that the polymer material comprises one or more olefin polymers.

11. The device as claimed in claim 10, characterized in that the olefin polymer is an ethylene/propylene/diene monomer terpolymer (EPDM).

12. The device as claimed in any one of the preceding claims, characterized in that it is an electric cable (1) comprising an elongated electrically conducting component surrounded by said crosslinked layer.

13. The device as claimed in claim 12, characterized in that the elongated conducting component (2) is surrounded by a first semiconducting layer (3), an electrically insulating layer (4) surrounding the first semiconducting layer, and a second semiconducting layer (5) surrounding the electrically insulating layer, the crosslinked layer being at least one of these three layers, and the crosslinked layer preferably being the electrically insulating layer (4).

14. The device as claimed in any one of claims 1 to 12, characterized in that it is an electric cable accessory (20, 30), said accessory comprising the crosslinked layer.

15. The device as claimed in claim 14, characterized in that the accessory is an electric cable joint or termination.
